(19) United States
(12) Patent Application Publication
(10) Pub. No.: US 2026/0152202 A1
(43) Pub. Date: Jun. 4, 2026

(54) OPERATION CONTROL SYSTEM AND INFORMATION PROCESSING DEVICE

(71) Applicant: TOYOTA JIDOSHA KABUSHIKI KAISHA, Toyota-shi (JP)

(72) Inventors: Yuko MATSUSHITA, Nagoya-shi (JP); Masayuki FUKUSHIMA, Saitama-shi (JP); Ryota YANAGISAWA, Nisshin-shi (JP)

(73) Assignee: TOYOTA JIDOSHA KABUSHIKI KAISHA, Toyota-shi (JP)

(21) Appl. No.: 19/383,829

(22) Filed: Nov. 10, 2025

(30) Foreign Application Priority Data
Dec. 3, 2024 (JP) 2024-210779

(51) Int. Cl. B60W 50/12; B60H 1/00

(52) U.S. Cl. CPC B60W 50/12; B60H 1/0073; B60H 2001/00733; B60W 2540/10; B60W 2710/30; B60W 2720/106

(57) ABSTRACT

The operation control system includes an information processing device having a first control unit, and plural control devices mounted on plural vehicles and each having a second control unit. The second control unit acquires, for each vehicle occupant, the set temperature of the air conditioning device as first information, and acquires the detected accelerator operation amount as second information. The first control unit calculates, for each vehicle occupant, a first suppression control value corresponding to the suppression rate of the output of the air conditioning device and a second suppression control value corresponding to the suppression rate of the acceleration output based on the first and second information. When one vehicle with the second control unit is in the eco-driving mode, the second control unit performs suppression control of the air conditioning device of the one vehicle and the acceleration output based on the first and second suppression control values.

### CROSS-REFERENCE TO RELATED APPLICATION

This application claims priority to Japanese Patent Application No. 2024-210779 filed on Dec. 3, 2024. The disclosure of the above-identified application, including the specification, drawings, and claims, is incorporated by reference herein in its entirety.

### BACKGROUND

### 1. Technical Field

The present disclosure relates to an operation control system and an information processing device.

### 2. Description of Related Art

There has been proposed an air-conditioning control system capable of appropriately controlling an air conditioning device mounted on a vehicle according to a user's preference for eco-driving (see Japanese Unexamined Patent Application Publication No. 2019-64523 (JP 2019-64523 A), for example).

### SUMMARY

In the air-conditioning control system described in JP 2019-64523 A, the control target is limited to the air conditioning device, and therefore it is not considered to adjust the control of the acceleration output during the eco-driving.

The present disclosure has been made in view of the above circumstances, and an object of the present disclosure is to provide an operation control system and an information processing device capable of appropriately controlling an air conditioning device and an acceleration output according to a preference of an occupant.

In order to address the above issue, an aspect of the present disclosure provides an operation control system including an information processing device including a first control unit, and a plurality of control devices respectively mounted on a plurality of vehicles and each including a second control unit, in which:
the second control unit acquires, for each occupant of a vehicle on which the control device is mounted, information on a set temperature of an air conditioning device as first information, and acquires information on an accelerator operation amount detected by an accelerator sensor as second information;
the first control unit calculates, for each occupant of each vehicle, a first suppression control value corresponding to a suppression rate of an output of the air conditioning device and a second suppression control value corresponding to a suppression rate of an acceleration output based on the first information and the second information acquired from the control device; and
when one vehicle on which the second control unit is mounted is in an eco-driving mode, the second control unit performs suppression control of the air conditioning device mounted on the one vehicle and the acceleration output based on the first suppression control value and the second suppression control value for the occupant acquired from the information processing device.

In order to address the above issue, an aspect of the present disclosure provides an information processing device including: a first communication unit that acquires, from a plurality of vehicles, first information relating to an operation of an air conditioning device by an occupant of each vehicle and second information relating to an operation of an accelerator of the vehicle by the occupant; and a first control unit that calculates, for each occupant of each vehicle, a first suppression control value to be used for suppression control of the air conditioning device and a second suppression control value to be used for suppression control of an acceleration output based on the first information and the second information.

According to the present disclosure, it is possible to provide an operation control system and an information processing device capable of suitably controlling an air conditioning device and an acceleration output according to a preference of an occupant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of an operation control system according to an embodiment;

FIG. 2 is a flowchart illustrating a procedure of a history information acquisition process performed by a control device of a vehicle during normal operation;

FIG. 3 is a flowchart showing a sequence of a suppression control value calculation process performed by the information processing device; and

FIG. 4 is a flowchart illustrating a procedure of a suppression control value adjustment process performed by the information processing device.

### DETAILED DESCRIPTION OF EMBODIMENTS

Hereinafter, an embodiment of an operation control system 1 of the present disclosure will be described with reference to the drawings.

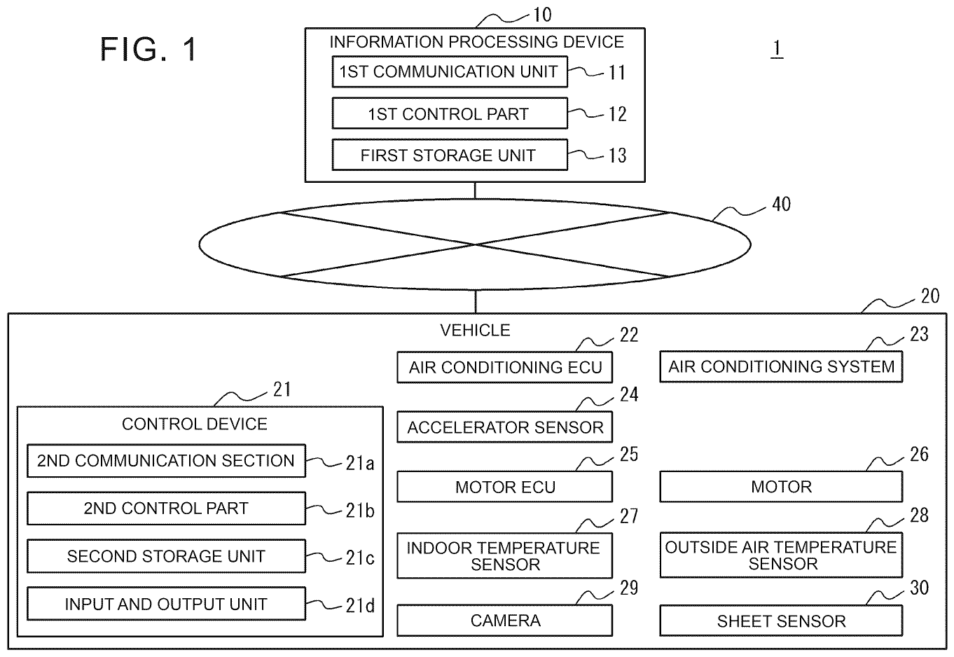

As illustrated in FIG. 1, the operation control system 1 includes an information processing device 10 and a plurality of control devices 21 mounted on the plurality of vehicles 20. The information processing device 10 and the respective control devices 21 are configured to be able to communicate with each other via a communication network 40.

The information processing device 10 is a computer belonging to a cloud computing system or another computing system. The information processing device 10 includes a first communication unit 11, a first control unit 12, and a first storage unit 13. The first communication unit 11 includes at least one external communication interface connected to the network 40. The first control unit 12 includes a processor and/or a dedicated circuit. The first control unit 12 performs various calculations based on information acquired from the vehicle 20. The first storage unit 13 includes at least one of a semiconductor memory, a magnetic memory, and an optical memory. The storage unit 13 stores information acquired from the vehicle 20 and information calculated by the information processing device 10.

The vehicle 20 is, for example, an automobile, but is not limited thereto, and is an arbitrary vehicle. The motor vehicle is, for example, but not limited to, a gasoline-powered motor vehicle or a battery electric vehicle (BEV; Battery Electric Vehicle). The vehicle 20 can operate in one of two modes: a normal operation mode and an eco-operation mode. The eco-driving mode is a mode in which energy consumption is suppressed and fuel consumption or electric power consumption is improved as compared with the normal driving mode.

The vehicle 20 includes a control device 21, an air conditioning ECU (Electronic Control Unit) 22, an air conditioning device 23, an accelerator sensor 24, a prime mover ECU 25, a prime mover 26, an indoor temperature sensor 27, and an outside air temperature sensor 28. The vehicle 20 may further include a camera 29 for imaging the occupant and/or a seat sensor 30 for detecting the occupant seated in the seat.

The control device 21 is an electronic device such as a computer mounted on a vehicle. The control device 21 includes a second communication unit 21a, a second control unit 21b, a second storage unit 21c, and an input/output unit 21d.

The second communication unit 21a includes an external communication interface connected to the network 40 by radio communication. The second control unit 21b includes a processor and/or dedicated circuitry, similar to the first control unit 12. The second control unit 21b can acquire the setting temperature of the air conditioning device 23 and the accelerator operation amount detected by the accelerator sensor 24. The second control unit 21b can control the outputting of the air conditioning device 23 and the prime mover 26 via the air conditioning ECU 22 and the prime mover ECU 25. Like the first storage unit 13, the second storage unit 21c includes at least one of a semiconductor memory, a magnetic memory, and an optical memory. The input/output unit 21d may be, for example, a touch panel. The occupant can instruct the control device 21 to switch between the eco-driving mode and the normal driving mode via the input/output unit 21d.

The air conditioning device 23 functions as a cooling device and/or a heating device by receiving electric power and/or heat from a battery of the vehicle 20 and/or a prime mover 26. The air conditioning ECU 22 controls the operation of the air conditioning device 23. In the normal operation mode, the occupant can set the temperature of cooling or heating by operating the air-conditioning panel in the vehicle 20. The air conditioning ECU 22 delivers the set temperature of cooling or heating to the control device 21 as the first information. The air conditioning ECU 22 controls the air conditioning device 23 so that the temperature in the room of the vehicles 20 becomes the set temperature. In the eco-operation mode, the air conditioning ECU 22 controls the air conditioning device 23 by suppressing the air-conditioning power specified by the control device 21 as compared with the normal operation mode.

The accelerator sensor 24 detects the accelerator operation amount, which is the amount of step-in of the accelerator pedal. The control device 21 acquires information on the accelerator operation amount and generates second information. The second information may include an accelerator operation amount and a jerk in accelerating. The accelerator operation amount represents the amount of depression of the accelerator pedal, for example, as a percentage. The jerk is a time differential value of the accelerator operation amount. The prime mover 26 converts fuel or electricity into mechanical energy to drive the vehicle 20. The prime mover 26 includes an engine and motor. The prime mover ECU 25 controls the power of the prime mover 26 in accordance with the accelerator operation amount detected by the accelerator sensor 24. The prime mover ECU 25 controls the prime mover 26 to be suppressed more than in the normal operation mode by the acceleration power specified by the control device 21 in the eco-operation mode.

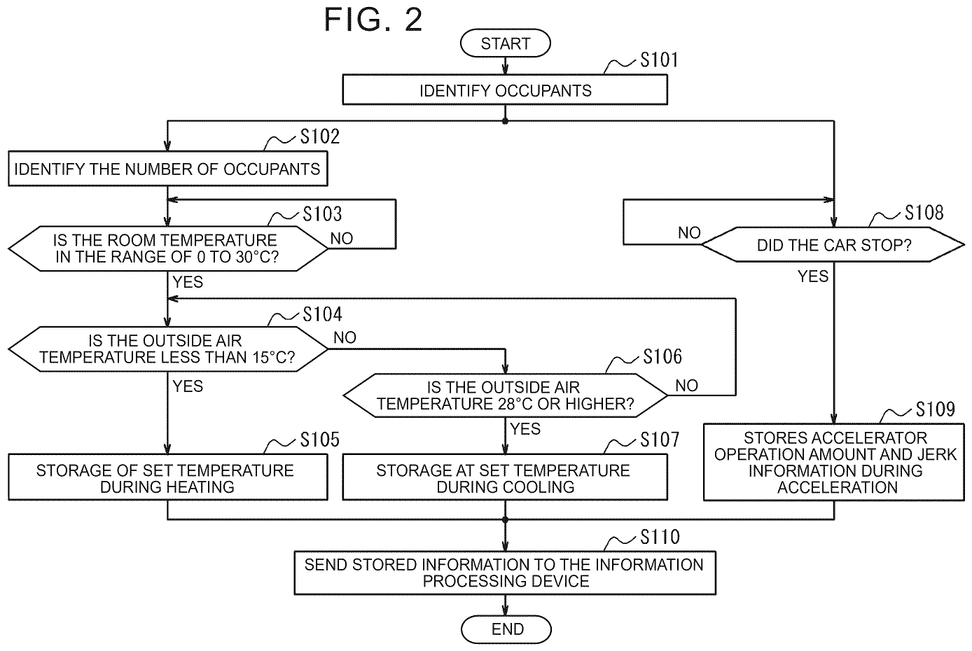

Next, a process executed by the operation control system 1 will be described with reference to the flowcharts of FIGS. 2 to 4.

As illustrated in FIG. 2, in the normal driving mode of the vehicle 20, the second control unit 21b identifies the occupant who has ridden on the vehicle 20 (S101). The second storage unit 21c may store information about an occupant who may be on the vehicles 20. The control device 21 may determine the actual occupant from the candidates of the occupant stored in the second storage unit 21c based on the images acquired by the camera 29 and/or the information of the occupant acquired by the seat sensor 30.

The second control unit 21b executes a process of S107 from S102 and a process of S109 from S108 in parallel or sequentially.

In S102, the second control unit 21b specifies the number of occupants on the basis of information acquired from the camera 29 or the seat sensor 30. The second control unit 21b acquires information on the indoor temperature of the vehicle 20 from the indoor temperature sensor 27, and when the indoor temperature is not in the range of 0 to 30 degrees (S103: No), controls the air conditioning device 23 to operate normally so that the indoor temperature is in the range of 0 to 30 degrees. The second control unit 21b proceeds to S104 when the indoor temperature is in the range of 0 to 30 degrees (S103: Yes). Next, when the outside air temperature is less than 15 degrees (S104: Yes), the second control unit 21b stores the heating time set temperature set by the occupant in the second storage unit 21c(S105). On the other hand, when the outside air temperature is 28 degrees or more (S106: Yes), the second control unit 21b stores the cooling-time set temperature set by the occupant in the second storage unit 21c (S107).

In S108, when the vehicle 20 stops (S108: Yes), the second control unit 21b acquires information about the accelerator operation amount and jerk at the time of starting the next travel. The obtained accelerator operation amount and jerk may be, for example, the maximum value during acceleration. The second control unit 21b causes the second storage unit 21c to store the accelerator operation amount and the jerk (S109).

The second control unit 21b periodically transmits, as the history information, the set temperature at the time of heating or cooling (first information) and the information on the accelerator operation amount and jerk (second information) to the information processing device 10 (S110).

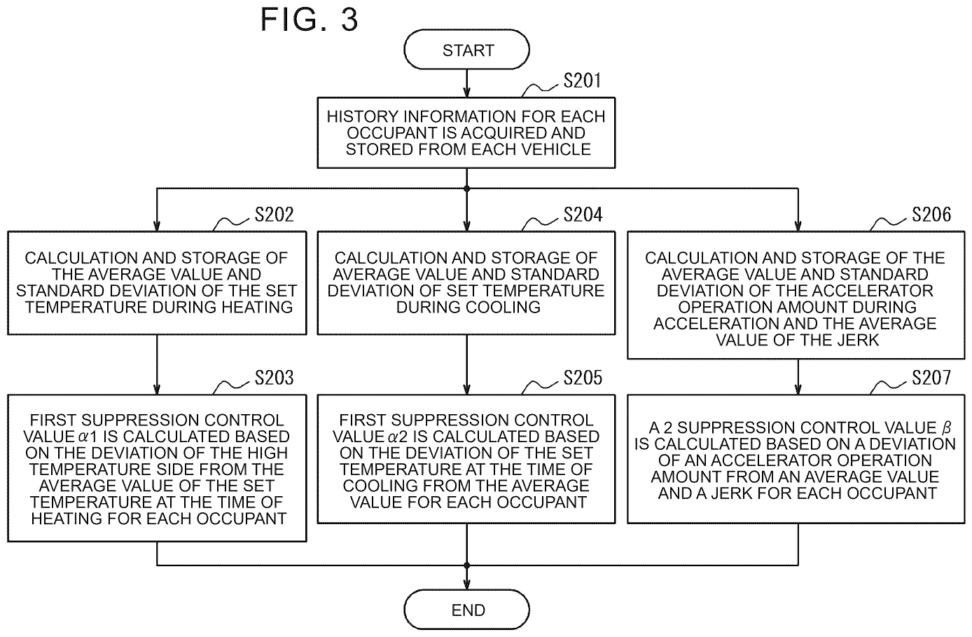

Next, a suppression control value calculation process executed by the first control unit 12 of the information processing device 10 will be described with reference to FIG. 3. In FIG. 3, the processes from S202 to S203, S204 to S205 and from S206 to S207 may be executed in parallel or sequentially.

First, the first control unit 12 acquires the history data for each occupant from the vehicles 20 included in the operation control system 1 and stores the history data in the first storage unit 13 (S201).

The first control unit 12 calculates an average value and a standard deviation of the set temperatures at the time of heating of all the occupants included in the history information collected from the plurality of vehicles 20 at appropriate timings, and stores the average value and the standard deviation in the first storage unit 13 (S202). The first control unit 12 calculates, for each occupant, a first suppression control value α1 at the time of heating based on a deviation of a set temperature at the time of heating of the occupant with respect to the mean value calculated by S202 (S203). The first suppression control value α1 at the time of heating is a numerical value of 0 or more and 1 or less. The first suppression control value α1 becomes a smaller value as the heating set temperature increases from the average value. As an example, the first control unit 12 sets the first suppression control value α1 at the time of heating to 0.5, 0.25, and 0.1, respectively, when the deviation of the set temperature at the time of heating by the occupant relative to the average value to the high temperature side is within 1σ, within 2σ greater than 1σ, and within 3σ greater than 2σ. 1σ, 2σ and 3σ represent 1, 2 and 3 times the standard deviation. When the occupant's heating set temperature is lower than the average value, the first suppression control value α1 is set to 0.5. The smaller the first suppression control value α1 at the time of heating is, the higher the set temperature at the time of heating is, and thus the occupant tends to cool.

The first control unit 12 calculates the first suppression control value α2 at the time of cooling by S204 and S205. S204 and S205 are similar to S202 and S203, and therefore will not be described.

The first control unit 12 calculates the average value and the standard-deviation of the accelerator operation amount and the average value of the jerks of all the occupants included in the history information collected from the plurality of vehicles 20, and stores the average value in the first storage unit 13 (S206). For each occupant, the first control unit 12 calculates the second suppression control value β on the basis of the deviation of the accelerator operation amount of the occupant with respect to the average value of the accelerator operation amount calculated by S206 and the comparison between the average value of the jerk and the value of the jerk of the occupant (S207). The second suppression control value β is a numerical value of 0 or more and 1 or less. As an example, when the deviation of the accelerator operation amount of the occupant toward the side larger than the average value is within 1σ and greater than 1σ and within 2σ, the first control unit 12 sets the second suppression control value β to 0.5 and 0.25, respectively. Further, when the jerk of the occupant is larger than the average value, the first control unit 12 sets a value obtained by subtracting 0.1 from the above-described second suppression control value β to the second suppression control value β. The smaller the second suppression control value β, the more the occupant tends to prefer quick acceleration.

On the vehicle 20 side, the first suppression control value α1 at the time of heating and the first suppression control value α2 at the time of cooling are not used simultaneously. Hereinafter, the first suppression control value α1 at the time of heating and the first suppression control value α2 at the time of cooling are collectively represented as the first suppression control value α. The first suppression control value α is a parameter that is set so as to decrease as the occupant prefers the air-conditioning temperature. The first suppression control value α corresponds to the suppression rate of the output of the air conditioning device 23. The second suppression control value β is a parameter that is set so as to be smaller as the occupant prefers the acceleration performance. The second suppression control value β corresponds to a suppression rate of the output of the prime mover 26 at the time of acceleration.

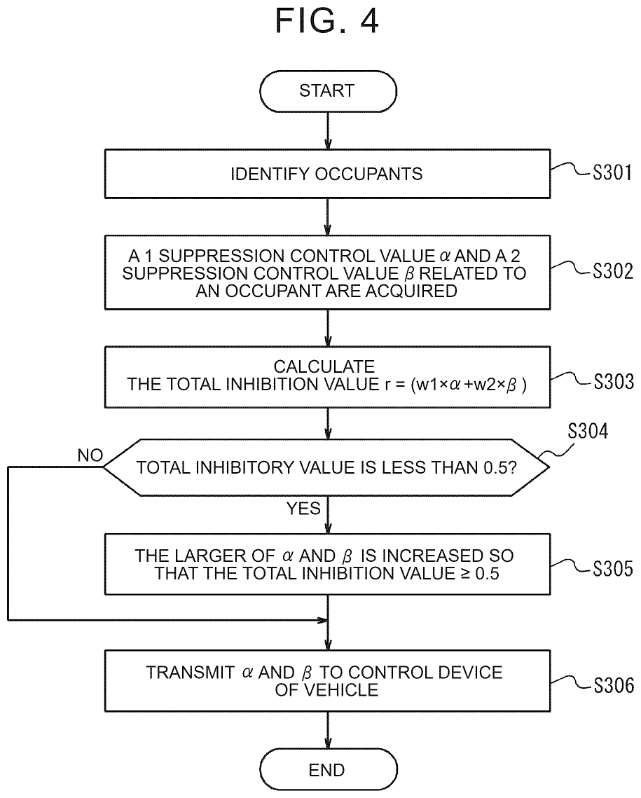

FIG. 4 illustrates an adjustment process of the suppression control value for each occupant by the first control unit 12 of the information processing device 10. The processing of FIG. 4 may be executed following the processing of FIG. 3, or may be executed when the information processing device 10 receives information indicating that the vehicle 20 is to operate in the eco-driving mode. Hereinafter, the latter case will be described.

First, the first control unit 12 acquires information from the control device 21 of the vehicle 20, and identifies the occupant who has ridden on the vehicle 20 (S301). Next, the first control unit 12 acquires the first suppression control value α and the second suppression control value β of the occupant stored in the second storage unit (S302). The first control unit 12 calculates the total suppression value r based on the first suppression control value α and the second suppression control value β (S303). The total suppression value r is calculated by, for example, Equation (1).

$$r = w 1 \times α + w 2 \times β \qquad ( 1 )$$

w1 and w2 are weights determined in accordance with the degree of contribution to the total energy-suppression between the output suppression of the air conditioning device 23 and the output suppression of the prime mover 26 at the time of acceleration. w1 and w2 may be determined such that the mean is 1.

When the total suppression value r is less than 0.5(S304: Yes), the first control unit 12 increases the value of the larger one of the first suppression control value α and the second suppression control value β so that the total suppression value r is equal to or greater than 0.5 (S305). When the sum suppression value r is 0.5 or more in S304 (S304: No) and after S305, the first control unit 12 transmits the first suppression control value α and the second suppression control value β to the control device 21 of the vehicle 20 via the first communication unit (S306). Note that the processing of FIG. 4 may be executed by the control device 21 of the vehicle 20.

The second control unit 21b of the control device 21 that has received the first suppression control value α and the second suppression control value β determines the output of the air conditioning device 23 of the vehicle 20 and the acceleration output of the prime mover 26. The output of the air conditioning device 23 is suppressed to a value obtained by multiplying the output value in the normal operation mode by 1−α. The acceleration output of the prime mover 26 is suppressed to a value obtained by multiplying the output value in the normal operation mode by 1−β. In S305, increasing the larger one of the first suppression control value α and the second suppression control value β is based on a determination that the occupant prefers the air-conditioning temperature or the acceleration performance corresponding to the smaller one of the suppression control values.

Examples including numerical values are shown below. The average value of the set temperature during heating is assumed to be 23 degrees, and the standard deviation is assumed to be 2 degrees. Further, the average value of the accelerator operation amount is assumed to be 50%, and the standard deviation is assumed to be 10%. Further, the weights w1 and w2 are assumed to be w1=w2=1. Here, it is assumed that the heating set temperature of a specific occupant is 26 degrees, the accelerator operation amount is 70%, and the jerk is larger than the average value. In this case, the first suppression control value α and the second suppression control value β corresponding to the occupant are 0.25 and 0.15, respectively. Since the first suppression control value α>the second suppression control value β, the occupant tends to prefer or place more importance on the acceleration performance than the air-conditioning temperature. Therefore, the first control unit 12 increases the first suppression control value α to 0.35, and sets the total suppression value r to 0.5. By doing so, the second control unit 21b that has acquired the first suppression control value α and the second suppression control value β keeps the suppression amount of the acceleration output of the vehicle 20 that is more important to the occupant, thereby suppressing the output of the air conditioning device 23 to a greater extent. As a result, the sum of the suppression amount of the output of the air conditioning device 23 and the suppression amount of the acceleration output becomes equal to or greater than a predetermined value, and the energy suppression performance targeted in the eco-driving mode is achieved.

As described above, according to the present embodiment, the information processing device 10 determines the first suppression control value α and the second suppression control value β on the basis of the set temperature of the air conditioning device 23 of the occupant and the information of the accelerator operation detected by the accelerator sensor 24. Further, the information processing device 10 adjusts the first suppression control value α or the second suppression control value β based on the preference of the occupant so as to obtain a predetermined energy suppression amount. The control device 21 of the vehicle 20 controls the air conditioning device 23 and the prime mover 26 in accordance with the first suppression control value α and the second suppression control value β adjusted in the eco-driving mode in accordance with the occupant's preference, so that the eco-driving performance of the vehicle 20 is improved.

The present disclosure is not limited to the above-described embodiments, and many modifications and variations are possible. For example, the first suppression control value α may be set to a different value depending on the number of people on the vehicle 20. The numerical information such as the temperature, the accelerator operation amount, the jerk, the suppression control value, the total suppression value, and the threshold value for these parameters used in the above-described embodiment is merely an example. In an actual system, these numerical values can be set as appropriate.

What is claimed is:

1. An operation control system comprising an information processing device including a first control unit, and a plurality of control devices respectively mounted on a plurality of vehicles and each including a second control unit, wherein:
the second control unit acquires, for each occupant of a vehicle on which the control device is mounted, information on a set temperature of an air conditioning device as first information, and acquires information on an accelerator operation amount detected by an accelerator sensor as second information;
the first control unit calculates, for each occupant of each vehicle, a first suppression control value corresponding to a suppression rate of an output of the air conditioning device and a second suppression control value corresponding to a suppression rate of an acceleration output based on the first information and the second information acquired from the control device; and
when one vehicle on which the second control unit is mounted is in an eco-driving mode, the second control unit performs suppression control of the air conditioning device mounted on the one vehicle and the acceleration output based on the first suppression control value and the second suppression control value for the occupant acquired from the information processing device.

2. An information processing device comprising:
a first communication unit that acquires, from a plurality of vehicles, first information relating to an operation of an air conditioning device by an occupant of each vehicle and second information relating to an operation of an accelerator of the vehicle by the occupant; and
a first control unit that calculates, for each occupant of each vehicle, a first suppression control value corresponding to a suppression rate of an output of the air conditioning device and a second suppression control value corresponding to a suppression rate of an acceleration output based on the first information and the second information.

3. The information processing device according to claim 2, wherein the first suppression control value is a parameter that is set so as to decrease as the occupant prefers an air-conditioning temperature, the second suppression control value is a parameter that is set so as to decrease as the occupant prefers acceleration performance, and the first control unit increases a larger one of the first suppression control value and the second suppression control value such that a total of the first suppression control value and the second suppression control value becomes equal to or larger than a predetermined value.

4. The information processing device according to claim 2, wherein the first information includes a set temperature, and the second information includes an accelerator operation amount and a jerk.

5. The information processing device according to claim 2, wherein the first control unit determines the first suppression control value based on a deviation of each piece of the first information from an average value of the first information, and determines the second suppression control value based on a deviation of each piece of the second information from an average value of the second information.
